(19) United States
(12) Patent Application Publication
(10) Pub. No.: US 2026/0288121 A1
(43) Pub. Date: Sep. 24, 2026

(54) CONSUMER-FACING ECO-FEEDBACK SYSTEM, MODEL, AND INTERFACE FOR REDUCING LARGE-SCALE AI CARBON EMISSIONS AND ENERGY USE

(71) Applicants: Georgia Tech Research Corporation, Atlanta, GA (US); Center for Technology Licensing ("CTL") at Cornell, Ithaca, NY (US)

(72) Inventors: Josiah Hester, Atlanta, GA (US); Udit Gupta, Ithaca, NY (US); Xuesi Chen, Ithaca, NY (US); Hyeonwook Kim, Atlanta, GA (US)

(21) Appl. No.: 19/532,966

(22) Filed: Feb. 6, 2026

Related U.S. Application Data
(60) Provisional application No. 63/755,921, filed on Feb. 7, 2025.

(51) Int. Cl. G05B 19/418; G06Q 30/018

(52) U.S. Cl. CPC G05B 19/4184; G05B 19/41845; G06Q 30/018

(57) ABSTRACT

A system for reducing carbon emissions associated with internet services includes a processor configured to receive a user selection of an eco mode from a plurality of eco modes, wherein each eco mode defines a distinct latency profile associated with a corresponding carbon emission reduction. The processor is configured to configure at least one carbon footprint reduction technique based on the selected eco mode, including renewable energy scheduling, batching, or request parallelism. The processor processes a user request according to the configured technique, applying a latency increase corresponding to the selected eco mode, calculates a carbon emission reduction, and generates an eco-feedback visualization displaying the calculated reduction. A memory stores eco mode configuration parameters including latency ratios for each eco mode.

### CROSS-REFERENCE TO RELATED APPLICATIONS

This application claims priority to U.S. Application No. 63/755,921, titled CONSUMER-FACING ECO-FEEDBACK SYSTEM, MODEL, AND INTERFACE FOR REDUCING LARGE-SCALE AI CARBON EMISSIONS AND ENERGY USE, filed Feb., 7 2025, which is hereby incorporated by reference in its entirety.

### STATEMENT REGARDING FEDERALLY SPONSORED RESEARCH

This invention was made with government support under 2324861, and 2324860 awarded by the National Science Foundation. The government has certain rights in the invention.

### FIELD OF INVENTION

The present disclosure relates to eco-feedback systems for reducing carbon emissions associated with information and communication technologies, and more particularly to a consumer-facing interface and method for enabling users to accept increased service latency in exchange for reduced carbon footprint when interacting with internet services and large language model applications.

### BACKGROUND

Modern information and communication technologies (ICT) account for a substantial portion of global carbon emissions, with estimates indicating that ICT contributes approximately four percent of global greenhouse gas emissions, placing it on par with the aviation industry. These emissions are expected to increase over the coming decade as demand for computing continues to grow from emerging applications such as augmented reality, virtual reality, scientific computing, cloud services, and artificial intelligence. The emergence of generative artificial intelligence has further accelerated infrastructure growth and is beginning to strain access to power, renewable energy, and water resources in local communities.

Cloud applications are designed to balance service metrics including quality of results, response time or latency, availability of service, and reliability to maximize user experience. Studies have shown that these dimensions are carefully balanced for each application, with web searches maintaining tight response times of less than 200 milliseconds to maintain user engagement. To meet user expectations for immediate service, infrastructure providers provision additional compute capacity and dedicated server racks, leading to higher overall carbon emissions.

Service level agreements (SLAs) between cloud service providers and customers define measurable goals that services are expected to achieve, with SLAs often setting strict latency targets. As a result, cloud service providers may forgo energy and hardware usage efficiency potential to meet strict latency targets, such as reducing workload parallelism to sacrifice hardware utilization for lower latency. This results in a higher carbon footprint as a result of low hardware utilization.

Carbon emissions for cloud service providers can be categorized into operational carbon and embodied carbon. Operational carbon refers to carbon emissions that occur during the usage of hardware plus the energy consumption for the operation of computing equipment. Embodied carbon refers to carbon that occurs during chip manufacturing processes and the construction of facilities and infrastructure.

Eco-feedback is defined as information presented during product-user interaction that prompts the user to adopt energy-saving or environmentally conscious strategies. Several user studies have found eco-feedback to be effective in changing user perceptions and behavior in contexts such as ride-sharing, building energy consumption, and transportation mode selection. However, much of eco-feedback research surrounds more traditional ideas of energy consumption such as car emissions or building electricity use, while conveying the impact of ICT tends to be more speculative in nature due to opaque back-end infrastructures. Additionally, there is little research investigating user perceptions of eco-feedback in relation to user experience parameters such as latency.

Large language models (LLMs) present particular environmental challenges, with training of a single large AI model estimated to produce hundreds of metric tons of carbon dioxide equivalent emissions. The increasing use of LLMs has been tied to higher greenhouse gas emissions, water usage, and rare earth mineral extraction. Latency in LLMs is typically decomposed into time to first token, which influences user perception of responsiveness, end-to-end latency encompassing total request-to-response time, and token-by-token latency affecting the smoothness of streaming interactions.

Researchers have explored opportunities to reduce carbon emissions while adhering to service level agreements, including methods to integrate power grids and data centers to operate computing clusters with renewable energy, and designing power and energy efficient servers for applications like artificial intelligence. However, these methods are limited by the need to design within strict constraints codified in service level agreements. There exists a design space to enable green computing by exploiting tradeoffs in service attributes such as quality, availability, and response times and their carbon footprint.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for reducing carbon emissions associated with internet services is provided. The system includes a processor configured to receive a user selection of an eco mode from a plurality of eco modes, wherein each eco mode of the plurality of eco modes defines a distinct latency profile associated with a corresponding carbon emission reduction. The processor is configured to configure at least one carbon footprint reduction technique based on the selected eco mode, wherein the at least one carbon footprint reduction technique includes at least one of renewable energy scheduling, batching, or request parallelism. The processor is configured to process a user request according to the configured at least one carbon footprint reduction technique, wherein processing the user request includes applying a latency increase corresponding to the selected eco mode. The processor is configured to calculate a carbon emission reduction associated with processing the user request according to the selected eco mode. The processor is configured to generate an eco-feedback visualization displaying the calculated carbon emission reduction. The system includes a memory coupled to the processor and configured to store eco mode configuration parameters including latency ratios for each eco mode of the plurality of eco modes.

According to other aspects of the present disclosure, the system may include one or more of the following features. The renewable energy scheduling may comprise routing the user request to a remote data center powered by renewable energy instead of a local data center powered by carbon-intensive electricity. The remote data center may have a carbon intensity of approximately 28 g CO₂/kWh and the local data center may have a carbon intensity of approximately 380 g CO₂/kWh. The batching may comprise grouping the user request with other user requests for simultaneous processing to achieve higher GPU utilization. The processor may be further configured to configure a batch size parameter based on the selected eco mode, wherein higher eco modes correspond to larger batch sizes.

The request parallelism may comprise increasing a number of requests processed simultaneously by a processing unit to improve server resource utilization. The eco-feedback visualization may comprise a carbon savings component displaying a difference between carbon emissions of the selected eco mode and carbon emissions of a default mode, an impact component displaying the calculated carbon emission reduction as tangible daily equivalents, and a tradeoff component displaying a scatter plot of latency versus carbon emissions across the plurality of eco modes. The tangible daily equivalents may comprise at least one of avoided PET bottle production, light bulb usage, or gasoline car travel. The latency ratios may comprise a time to first token ratio and a token-by-token latency ratio for each eco mode of the plurality of eco modes. The processor may be further configured to calculate the carbon emission reduction as a sum of an operational carbon emission reduction and an embodied carbon emission reduction. The operational carbon emission reduction may be calculated based on thermal design power of processing units scaled by utilization factors, and the embodied carbon emission reduction may be calculated by amortizing hardware manufacturing costs over a device lifetime.

According to another aspect of the present disclosure, a method for reducing carbon emissions associated with internet services is provided. The method includes receiving, by a processor, a user selection of an eco mode from a plurality of eco modes, wherein each eco mode of the plurality of eco modes is associated with a distinct latency profile and a corresponding carbon emission reduction. The method includes configuring, by the processor, at least one carbon footprint reduction technique based on the selected eco mode. The method includes processing, by the processor, a user request according to the configured at least one carbon footprint reduction technique, wherein processing the user request includes applying a latency increase corresponding to the selected eco mode. The method includes calculating, by the processor, a carbon emission reduction associated with processing the user request according to the selected eco mode. The method includes presenting, via an output device, an eco-feedback interface displaying the calculated carbon emission reduction to a user.

According to other aspects of the present disclosure, the method may include one or more of the following features. Configuring the at least one carbon footprint reduction technique may comprise configuring renewable energy scheduling to route the user request to a remote data center powered by renewable energy. Routing the user request to the remote data center may add approximately 150 milliseconds of latency to the user request.

Configuring the at least one carbon footprint reduction technique may comprise configuring batching to group the user request with other user requests for simultaneous processing during inferencing. Presenting the eco-feedback interface may comprise displaying the calculated carbon emission reduction as tangible daily equivalents including at least one of avoided PET bottle production, light bulb usage, or gasoline car travel. Calculating the carbon emission reduction may comprise summing an operational carbon emission reduction based on energy consumption during request processing and an embodied carbon emission reduction based on amortized hardware manufacturing costs.

According to another aspect of the present disclosure, a non-transitory computer-readable medium storing instructions is provided. The instructions, when executed by a processor, cause the processor to present an eco-feedback interface including a selection mechanism for a plurality of eco modes, wherein each eco mode of the plurality of eco modes defines a distinct latency profile associated with a corresponding carbon emission reduction.

The instructions cause the processor to receive a user selection of an eco mode from the plurality of eco modes. The instructions cause the processor to configure at least one carbon footprint reduction technique based on the selected eco mode, wherein the at least one carbon footprint reduction technique adjusts at least one of data center routing, batch processing parameters, or request parallelism settings. The instructions cause the processor to process a user request according to the configured at least one carbon footprint reduction technique.

The instructions cause the processor to calculate a carbon emission reduction associated with processing the user request according to the selected eco mode. The instructions cause the processor to display the calculated carbon emission reduction in the eco-feedback interface.

According to other aspects of the present disclosure, the non-transitory computer-readable medium may include one or more of the following features. The instructions may further cause the processor to display the calculated carbon emission reduction as tangible daily equivalents comprising at least one of avoided PET bottle production, light bulb usage, or gasoline car travel. The instructions may further cause the processor to display a scatter plot visualization showing latency versus carbon emissions across the plurality of eco modes, wherein the scatter plot visualization updates with each processed user request.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates an eco-feedback system depicting a performance-oriented configuration for user interaction with cloud services, according to aspects of the present disclosure.

FIG. 1B illustrates the eco-feedback system of FIG. 1A depicting an eco search configuration operating under a slower is greener paradigm, according to aspects of the present disclosure.

FIG. 2 depicts a user acceptance survey results chart illustrating likelihood of user acceptance of user experience parameter trade-offs, according to an embodiment.

FIG. 3 depicts a latency preference comparison chart illustrating user preference distributions across different latency conditions, according to aspects of the present disclosure.

FIG. 4 depicts a likelihood score distribution chart illustrating user responses regarding eco-feedback interface setup options, according to an embodiment.

FIG. 5A depicts a diagram illustrating a renewable energy scheduling technique for carbon footprint reduction, according to aspects of the present disclosure.

FIG. 5B depicts a diagram illustrating a requests parallelism technique for carbon footprint reduction, according to aspects of the present disclosure.

FIG. 5C depicts a diagram illustrating a batching technique for carbon footprint reduction, according to aspects of the present disclosure.

FIG. 6A depicts carbon per query emissions and latency for large language model applications (LLM), according to aspects of the present disclosure.

FIG. 6B depicts carbon per query emissions and latency for e-commerce applications, according to aspects of the present disclosure.

FIG. 6C depicts per query emissions and latency for web search applications, according to aspects of the present disclosure.

FIG. 6D depicts per query emissions and latency for social network applications, according to aspects of the present disclosure.

FIG. 7A depicts time to first (TTF) token latency for different eco-modes, according to aspects of the present disclosure.

FIG. 7B depicts time to End-to-End latency for different eco-modes, according to aspects of the present disclosure.

FIG. 7C depicts token-by-token (TBT) latency for different eco-modes, according to aspects of the present disclosure.

FIG. 7D depicts greenhouse gas emission results for different eco-modes, according to aspects of the present disclosure.

FIG. 8A depicts a large language model eco-feedback interface showing interface components and eco feedback data visualization elements, according to aspects of the present disclosure.

FIG. 8B depicts metrics of latency and GHG emissions, according to aspects of the present disclosure.

FIG. 8C depicts carbon savings between an eco mode and performance mode, according to aspects of the present disclosure.

FIG. 8D depicts a daily impact equivalent from yearly query usage, according to aspects of the present disclosure.

FIG. 8E depicts a trade-off graph of carbon emissions against latency across different eco modes, according to aspects of the present disclosure.

FIG. 9 depicts survey interface screens illustrating sample survey questions presented during usability testing, according to aspects of the present disclosure.

FIG. 10 illustrates a block diagram of a system for providing eco-feedback functionality, according to an embodiment.

FIG. 11 illustrates a block diagram of a device that may be used to implement aspects of the eco-feedback system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

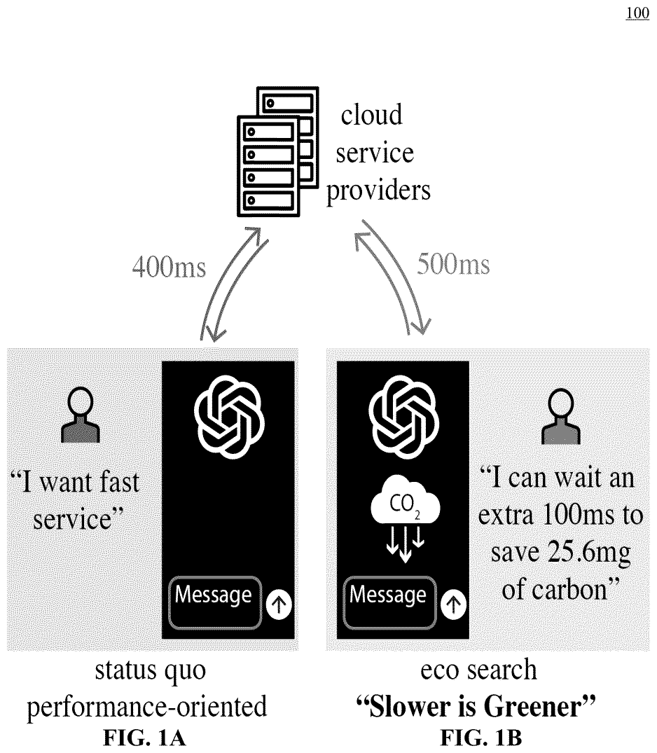

Referring to FIGS. 1A-1B, an eco-feedback system 100 may be configured to reduce carbon emissions associated with cloud service providers by enabling users to accept increased service latency in exchange for environmental benefits. The eco-feedback system 100 may operate in multiple configurations that provide different tradeoffs between service response time and carbon footprint reduction. As used herein, the term “processor” may comprise a single processor, a plurality of processors, cloud computing resources, distributed computing systems, or other processor configurations capable of executing the operations described herein.

FIG. 1A illustrates a performance-oriented configuration of the eco-feedback system 100 where a user device communicates with cloud service providers. In the performance-oriented configuration, a user expressing a preference for fast service may send requests to the cloud service providers with a response time of 400 ms. The user device may display a messaging interface with text indicating the user's preference for performance-optimized service delivery. In this configuration, the eco-feedback system 100 may prioritize minimizing latency without consideration of carbon emissions associated with processing the user's requests.

With continued reference to FIGS. 1A-1B, FIG. 1B illustrates an eco search configuration of the eco-feedback system 100 operating under a “Slower is Greener” paradigm. In the eco search configuration, the user device may communicate with the same cloud service providers but with an extended response time of 500 ms. The user device may display a messaging interface with a CO2 indicator and text indicating the user's willingness to accept increased latency in exchange for reduced carbon emissions. The 100 ms difference in response time between the performance-oriented configuration and the eco search configuration may correspond to a carbon savings of 25.6 mg per request.

The eco-feedback system 100 may provide five distinct eco modes with increasing latency degradation and descending embodied carbon emission. A default mode may utilize 4 GPUs with a batch size of 1. Eco mode 1 through eco mode 5 may progressively increase latency while reducing carbon emissions, with eco mode 5 utilizing 2 GPUs with a batch size of 128 and renewable energy scheduling (RES). Each eco mode may define a distinct latency profile tied to varying carbon impacts determined by back-end hardware configurations including GPU allocation, batch processing parameters, and renewable energy scheduling.

The eco-feedback system 100 may be applied to various internet services. The eco-feedback system 100 may be configured for use with search engines such as Google, social media platforms such as Instagram, e-commerce platforms such as Amazon, and large language model (LLM) chatbots such as ChatGPT. The eco-feedback system 100 may evaluate latency tradeoffs for different service types based on the nature of user interactions with each service.

For search engines and e-commerce platforms, the eco-feedback system 100 may evaluate latency tradeoffs associated with loading and page navigation operations. For LLM chatbots, the eco-feedback system 100 may evaluate latency tradeoffs associated with loading query answers. For social media platforms, the eco-feedback system 100 may evaluate latency tradeoffs associated with loading videos, loading feeds, and performing refreshes.

The eco-feedback system 100 may present users with visual feedback elements showing the environmental impact of selecting different eco modes for each service type.

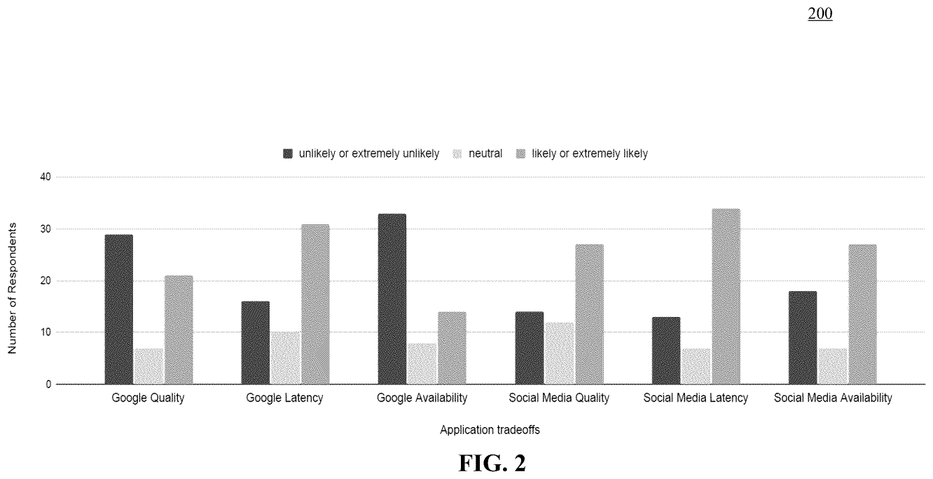

Referring to FIG. 2, a user acceptance survey results chart 200 illustrates the likelihood that users accept given user experience parameter tradeoffs for respective applications. The user acceptance survey results chart 200 presents data from participants who were asked to rate the likelihood of accepting a user experience parameter degradation on a Likert scale from 1 (extremely unlikely) to 5 (extremely likely) for both Google Search and Social Media applications. The eco-feedback system 100 may utilize such survey data to determine which user experience parameters users are willing to trade off in exchange for carbon emissions reductions.

With continued reference to FIG. 2, the user acceptance survey results chart 200 displays six categories of application tradeoffs along a horizontal axis: Google Quality, Google Latency, Google Availability, Social Media Quality, Social Media Latency, and Social Media Availability. A vertical axis of the user acceptance survey results chart 200 represents the number of respondents ranging from 0 to 40. For each category, three bars are shown representing responses classified as unlikely or extremely unlikely, neutral, and likely or extremely likely. The user acceptance survey results chart 200 may enable the eco-feedback system 100 to identify which tradeoff dimensions are most acceptable to users across different service types.

As further shown in FIG. 2, the user acceptance survey results chart 200 indicates that for Google Quality, approximately 29 respondents indicated unlikely or extremely unlikely, approximately 7 indicated neutral, and approximately 21 indicated likely or extremely likely. For Google Latency, approximately 16 respondents indicated unlikely or extremely unlikely, approximately 10 indicated neutral, and approximately 31 indicated likely or extremely likely. For Google Availability, approximately 33 respondents indicated unlikely or extremely unlikely, approximately 8 indicated neutral, and approximately 14 indicated likely or extremely likely. The distribution of responses in the user acceptance survey results chart 200 demonstrates that latency tradeoffs may be more acceptable to users than quality or availability tradeoffs for search applications.

With continued reference to FIG. 2, the user acceptance survey results chart 200 indicates that for Social Media Quality, approximately 14 respondents indicated unlikely or extremely unlikely, approximately 12 indicated neutral, and approximately 27 indicated likely or extremely likely. For Social Media Latency, approximately 13 respondents indicated unlikely or extremely unlikely, approximately 7 indicated neutral, and approximately 34 indicated likely or extremely likely. For Social Media Availability, approximately 18 respondents indicated unlikely or extremely unlikely, approximately 7 indicated neutral, and approximately 27 indicated likely or extremely likely. The eco-feedback system 100 may utilize the 5-point Likert scale for satisfaction ratings and likelihood assessments to quantify user preferences across different service types and tradeoff dimensions.

The eco-feedback system 100 may be designed to target users aged 18-24 years old who are reported to be the most eco-minded demographic and most frequent users of LLM technologies. The user acceptance survey results chart 200 may reflect data collected from participants within this demographic range to capture user perspectives representative of service users who demonstrate both environmental concern and technological literacy. The eco-feedback system 100 may leverage insights from the user acceptance survey results chart 200 to configure eco-feedback interfaces that align with user preferences for latency tradeoffs while avoiding tradeoffs in quality or availability that users may find less acceptable.

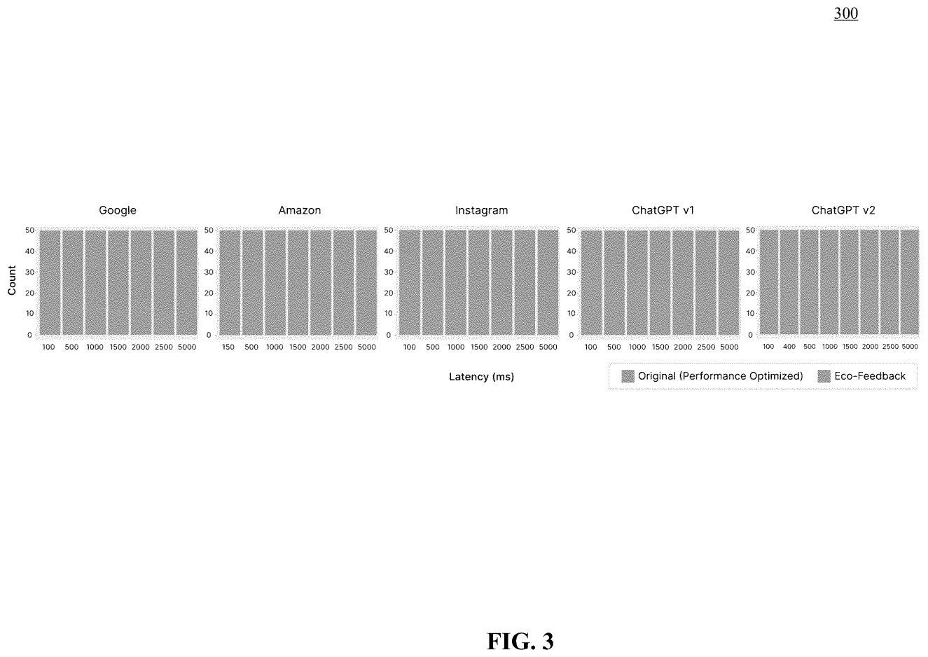

Referring to FIG. 3, a latency preference comparison chart 300 illustrates user preference distributions across different latency conditions for five internet services. The latency preference comparison chart 300 displays stacked bar graphs for Google, Amazon, Instagram, ChatGPT v1, and ChatGPT v2. A horizontal axis of the latency preference comparison chart 300 represents latency values in milliseconds ranging from 100 to 5000 ms, and a vertical axis represents count values from 0 to 50. The eco-feedback system 100 may apply eco-feedback interfaces with delay times ranging from 100 ms to 5000 ms for different services including Google, Instagram, Amazon, and ChatGPT.

With continued reference to FIG. 3, each bar in the latency preference comparison chart 300 is divided into two portions. A first portion shown in a first color represents original performance optimized interface preferences, and a second portion shown in a second color represents eco-feedback interface preferences. The latency preference comparison chart 300 demonstrates that as latency increases across all services, the proportion of users preferring the eco-feedback interface generally decreases. The eco-feedback system 100 may utilize the latency preference comparison chart 300 to identify latency thresholds at which user acceptance of eco-feedback interfaces remains favorable for each service type.

As further shown in FIG. 3, the latency preference comparison chart 300 indicates that ChatGPT v1 and ChatGPT v2 show relatively higher eco-feedback preference retention at higher latency values compared to Google, Amazon, and Instagram. The latency preference comparison chart 300 may enable the eco-feedback system 100 to determine that LLM chatbot services exhibit different user tolerance characteristics for latency tradeoffs than search engines, e-commerce platforms, and social media platforms. The eco-feedback system 100 may configure service-specific latency parameters based on the preference distributions shown in the latency preference comparison chart 300.

The eco-feedback system 100 may use a chi-square test of independence to determine if there is a significant relationship between latency and eco-search video preference. The chi-square test of independence may be conducted to examine whether there is a significant association between latency and user preference for performance-optimized search versus eco-search. The eco-feedback system 100 may analyze the data represented in the latency preference comparison chart 300 using the chi-square test of independence to quantify the strength of association between latency conditions and user preference changes for each service type. The chi-square test of independence may enable the eco-feedback system 100 to identify which services exhibit stronger or weaker relationships between latency and preference, thereby informing the configuration of eco-feedback interfaces for different application categories.

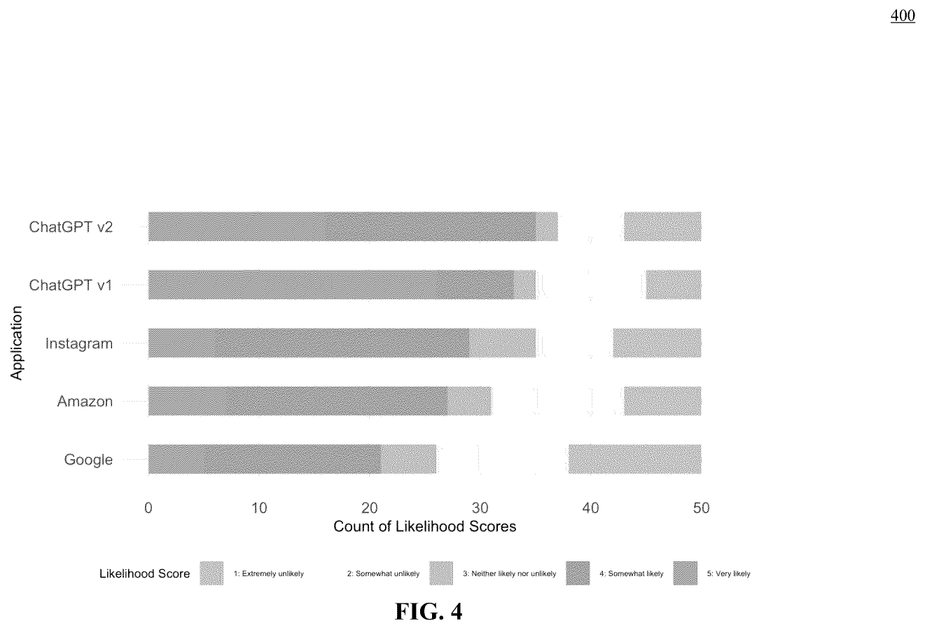

Referring to FIG. 4, a likelihood score distribution chart 400 illustrates user responses regarding the option to set up an eco-feedback interface before using each service. The likelihood score distribution chart 400 presents horizontal stacked bar graphs for five different applications: ChatGPT v2, ChatGPT v1, Instagram, Amazon, and Google. Each bar in the likelihood score distribution chart 400 displays the count of likelihood scores ranging from 1 (Extremely unlikely) to 5 (Very likely), with different colors representing each score category. A horizontal axis of the likelihood score distribution chart 400 shows the count of likelihood scores from 0 to 50, while a vertical axis lists the applications.

With continued reference to FIG. 4, the likelihood score distribution chart 400 demonstrates that ChatGPT v1 and ChatGPT v2 show higher proportions of participants indicating they are somewhat likely or very likely to use the eco-feedback interface setting compared to Google, Amazon, and Instagram. The likelihood score distribution chart 400 indicates that Google and Amazon display more distributed responses across the likelihood categories. The eco-feedback system 100 may utilize the likelihood score distribution chart 400 to identify which services exhibit the highest user willingness to engage with eco-feedback interface settings prior to use.

As further shown in FIG. 4, the likelihood score distribution chart 400 indicates that for ChatGPT v1, a majority of participants selected scores of 4 (somewhat likely) or 5 (very likely), demonstrating favorable user reception toward setting up eco-feedback interfaces for LLM chatbot services. The likelihood score distribution chart 400 indicates that Instagram shows a distribution where participants selecting somewhat likely or very likely exceed those selecting unlikely or extremely unlikely. The eco-feedback system 100 may configure default eco-mode settings based on the likelihood distributions shown in the likelihood score distribution chart 400 to maximize user engagement with carbon-saving features.

The eco-feedback system 100 may use logistic regression analysis to evaluate how different latency conditions affect user preferences for eco-feedback interfaces. The logistic regression analysis may analyze the impact of different latency values on user preferences and identify which latency conditions lead to a significant change in user preference. The eco-feedback system 100 may apply the logistic regression analysis to data collected from user studies to quantify the relationship between latency degradation and the likelihood of users selecting eco-feedback interfaces over performance-optimized interfaces for each service type.

The eco-feedback system 100 may use mixed-effects logistic regression with random intercepts for participants to analyze eco-mode preference while accounting for within-subject design. The mixed-effects logistic regression may account for repeated measures where each participant evaluates multiple eco modes. The eco-feedback system 100 may include predictors in the mixed-effects logistic regression such as eco mode, standardized difference recognition, carbon recognition, and latency recognition. The mixed-effects logistic regression may report results as odds ratios, confidence intervals, and p-values to quantify the effects of different factors on eco-mode preference. The eco-feedback system 100 may utilize the mixed-effects logistic regression to determine that carbon-saving recognition promotes eco preference while latency recognition acts as a barrier to eco-mode adoption.

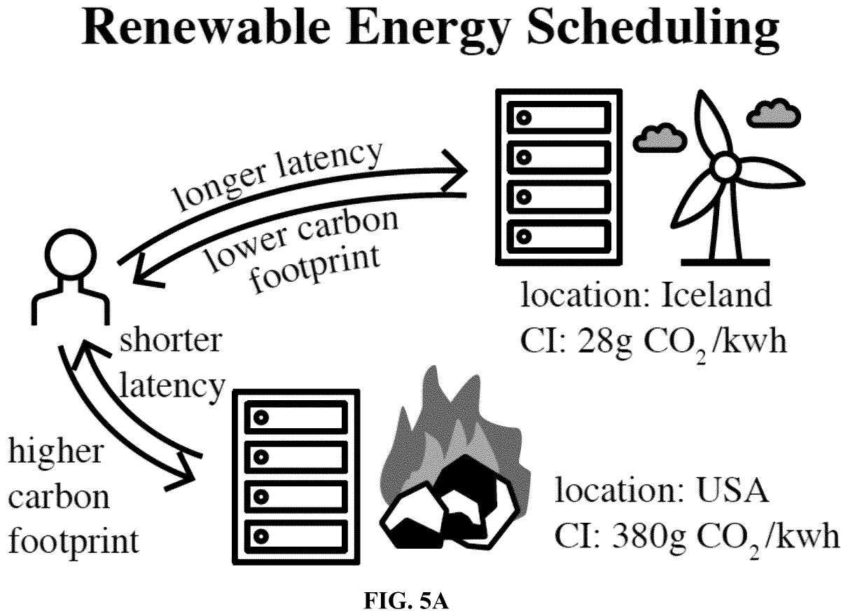

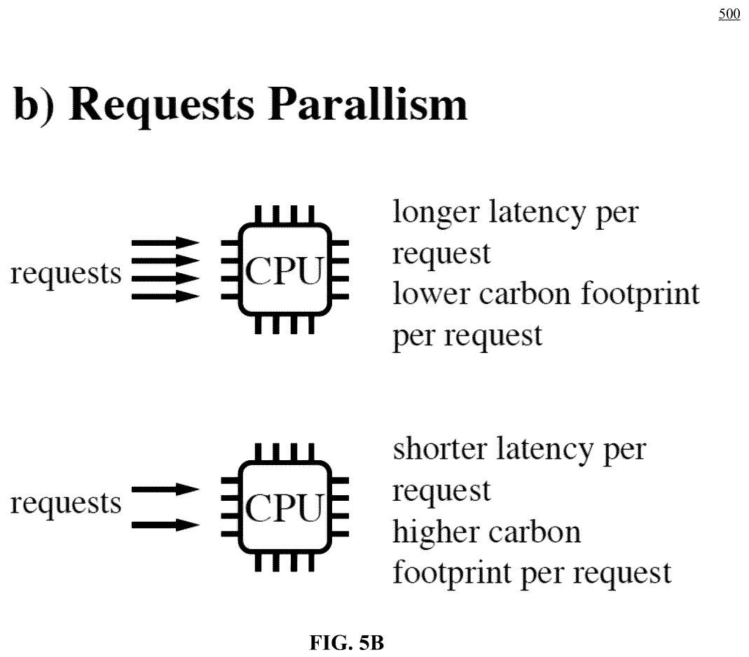

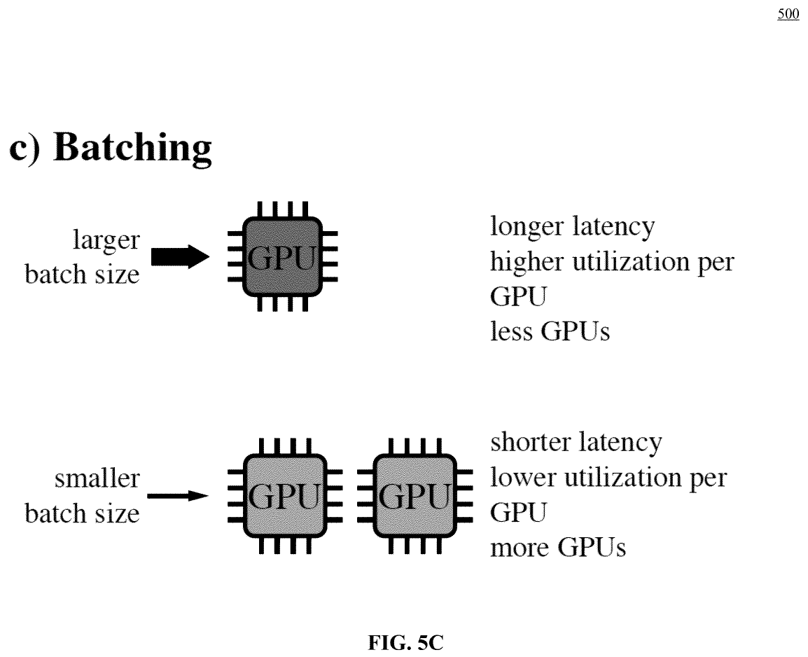

Referring to FIG. 5A, three system-level carbon footprint reduction techniques 500 may be implemented by the eco-feedback system 100 to reduce carbon emissions associated with internet service requests. FIG. 5A illustrates a renewable energy scheduling technique as one of the three system-level carbon footprint reduction techniques 500. The renewable energy scheduling technique may route user requests to a remote data center powered by renewable energy rather than a nearby data center powered by carbon-intensive electricity.

With continued reference to FIG. 5A, the three system-level carbon footprint reduction techniques 500 depict two possible paths for sending requests from a user to data centers. A first path may lead to a data center located in Iceland with a carbon intensity of 28 g CO₂/kWh, where the data center is powered by renewable energy sources such as wind power. A second path may lead to a data center located in the United States with a carbon intensity of 380 g CO₂/kWh, where the data center is powered by carbon-intensive electricity sources such as fossil fuels. The eco-feedback system 100 may implement renewable energy scheduling by directing user requests along the first path to the data center in Iceland when users select an eco mode that permits increased latency.

As further shown in FIG. 5A, the first path to the data center in Iceland is associated with longer latency and lower carbon footprint, while the second path to the data center in the United States is associated with shorter latency and higher carbon footprint. The eco-feedback system 100 may add approximately 150 ms of latency when routing requests to the remote data center powered by renewable energy. The 150 ms latency value may correspond to a round-trip latency for sending data between the United States and Iceland or between California and the Netherlands.

The eco-feedback system 100 may achieve up to 13.6× reduction in operational carbon through renewable energy scheduling by routing requests to data centers powered by renewable energy. The renewable energy scheduling technique may calculate carbon emission reductions based on the difference between the carbon intensity of the local data center and the carbon intensity of the remote data center powered by renewable energy. The eco-feedback system 100 may utilize the carbon intensity values of 380 g CO₂/kWh for US grid power and 28 g CO₂/kWh for Iceland renewable energy when calculating the benefits of renewable energy scheduling for users who select eco modes that permit the additional latency.

Referring to FIG. 5B, a requests parallelism technique is illustrated as one of the three system-level carbon footprint reduction techniques 500 that may be implemented by the eco-feedback system 100. The requests parallelism technique may increase the number of requests that a CPU or GPU can handle simultaneously to improve server resource utilization and reduce idle times. The requests parallelism technique may result in lower overall energy consumption and operational carbon emissions by processing multiple requests concurrently rather than sequentially.

With continued reference to FIG. 5B, the requests parallelism technique depicts two configurations for processing requests through a CPU. In a first configuration, multiple requests enter a CPU with longer latency per request and lower carbon footprint per request. In a second configuration, fewer requests enter a CPU with shorter latency per request and higher carbon footprint per request. The eco-feedback system 100 may implement the requests parallelism technique by directing user requests to the first configuration when users select an eco mode that permits increased latency.

As further shown in FIG. 5B, the requests parallelism technique demonstrates a tradeoff between request parallelism, latency, and carbon emissions. Higher request parallelism may result in better utilization per server node, thereby reducing the number of hardware resources required to handle a given volume of requests. The eco-feedback system 100 may leverage the requests parallelism technique to reduce both operational carbon emissions through improved energy efficiency and embodied carbon emissions through reduced hardware requirements.

The eco-feedback system 100 may implement tensor parallelism by reducing the number of GPUs on which an LLM is deployed. The tensor parallelism technique may utilize fewer hardware resources to reduce carbon emissions while increasing processing times for individual requests. The eco-feedback system 100 may configure tensor parallelism parameters based on the eco mode selected by a user, where higher eco modes may deploy the LLM on fewer GPUs with correspondingly longer processing times and lower carbon footprint per request.

The requests parallelism technique may enhance request parallelism before reaching peak throughput to reduce the overall carbon footprint at the expense of increased latency. The eco-feedback system 100 may balance the number of concurrent requests processed against the latency experienced by individual users based on the eco mode configuration. The requests parallelism technique may contribute to the overall carbon emission reduction achieved by the eco-feedback system 100 when combined with renewable energy scheduling and batching techniques.

Referring to FIG. 5C, a batching technique is illustrated as one of the three system-level carbon footprint reduction techniques 500 that may be implemented by the eco-feedback system 100. The batching technique may group incoming requests and process the grouped requests simultaneously during inferencing to achieve higher throughput and better GPU utilization by trading off latency. The batching technique may reduce both operational carbon emissions and embodied carbon emissions by improving the efficiency of GPU resource utilization.

With continued reference to FIG. 5C, the batching technique depicts two configurations for GPU utilization based on batch size. In a first configuration, a larger batch size is directed to a single GPU, which results in longer latency, higher utilization per GPU, and fewer GPUs required to handle a given volume of requests. In a second configuration, a smaller batch size is directed to two GPUs, which results in shorter latency, lower utilization per GPU, and more GPUs required. The GPU receiving the larger batch size is shown with darker shading to indicate high utilization, while the GPUs receiving the smaller batch size are shown with lighter shading to indicate low utilization.

As further shown in FIG. 5C, the batching technique demonstrates a tradeoff between batch size, latency, and carbon emissions. Smaller batch sizes may result in lower latency but lack parallelism, leading to smaller throughput and lower energy efficiency, thereby increasing operational carbon footprint. Smaller batch sizes may also underutilize GPUs, requiring more GPUs to handle the same task volume, thereby increasing embodied carbon footprint. Larger batch sizes may reduce runtime per query, improve GPU utilization, and decrease the number of GPUs required, thereby lowering the overall carbon footprint at the cost of higher latency for each query.

The eco-feedback system 100 may implement the batching technique by configuring batch size parameters based on the eco mode selected by a user. Higher eco modes may utilize larger batch sizes with correspondingly longer processing times and lower carbon footprint per request. The eco-feedback system 100 may group user requests into batches when users select eco modes that permit increased latency, thereby enabling the batching technique to process multiple requests simultaneously rather than individually. The batching technique may contribute to the overall carbon emission reduction achieved by the eco-feedback system 100 when combined with renewable energy scheduling and requests parallelism techniques.

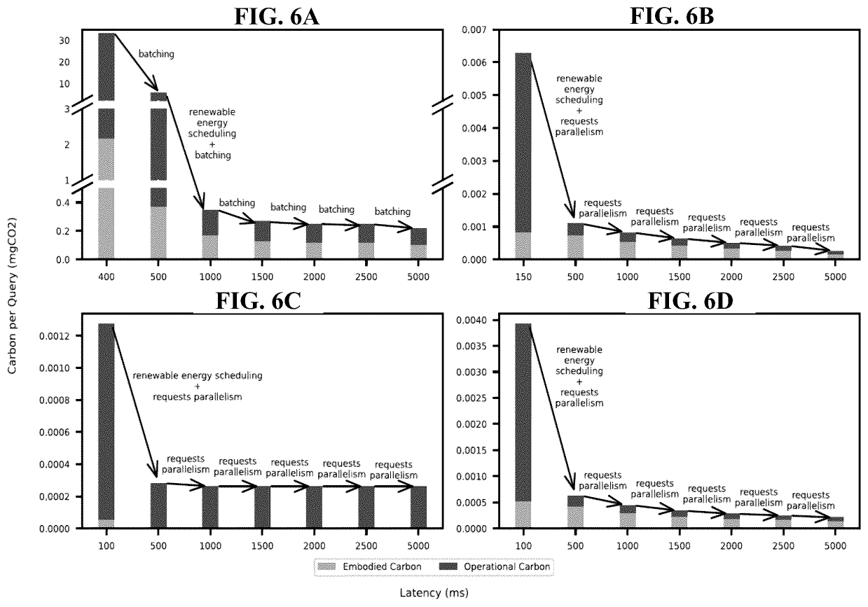

Referring to FIG. 6, carbon footprint comparison charts 600 illustrate the relationship between carbon emissions per query and latency across four different application types: LLM (FIG. 6A), E-Commerce (FIG. 6B), Web Search (FIG. 6C), and Social Network (FIG. 6D). The carbon footprint comparison charts 600 display stacked bar graphs showing embodied carbon and operational carbon at various latency values measured in milliseconds. The eco-feedback system 100 may calculate total carbon emissions as the sum of operational carbon and embodied carbon, where operational carbon represents emissions from electricity consumption during inference and embodied carbon represents emissions from chip manufacturing and facility construction.

With continued reference to FIG. 6A, the carbon footprint comparison charts 600 include an LLM chart showing carbon per query values ranging from approximately 30 mgCO₂ at 400 ms latency down to less than 1 mgCO₂ at 5000 ms latency. The LLM chart includes annotations indicating batching and renewable energy scheduling plus batching as carbon reduction techniques applied at different latency transition points. The eco-feedback system 100 may apply the batching technique from the three system-level carbon footprint reduction techniques 500 to LLM applications to achieve carbon reductions as latency targets are relaxed.

As further shown in FIG. 6B, the carbon footprint comparison charts 600 include an E-Commerce chart displaying carbon per query values ranging from approximately 0.007 mgCO₂ at 150 ms latency down to approximately 0.001 mgCO₂ at 5000 ms latency. The E-Commerce chart includes annotations for renewable energy scheduling plus requests parallelism as carbon reduction techniques. The eco-feedback system 100 may apply renewable energy scheduling and requests parallelism from the three system-level carbon footprint reduction techniques 500 to e-commerce applications to reduce carbon emissions when users accept increased latency.

With continued reference to FIG. 6C, the carbon footprint comparison charts 600 include a Web Search chart showing carbon per query values ranging from approximately 0.0012 mgCO₂ at 100 ms latency down to approximately 0.0003 mgCO₂ at 5000 ms latency. The Web Search chart includes annotations indicating renewable energy scheduling plus requests parallelism as carbon reduction techniques applied at different latency transition points. The carbon footprint comparison charts 600 also include a Social Network chart, in FIG. 6D, displaying carbon per query values ranging from approximately 0.004 mgCO₂ at 100 ms latency down to approximately 0.001 mgCO₂ at 5000 ms latency, with annotations for renewable energy scheduling plus requests parallelism.

As further shown in FIGS. 6A-D, each chart within the carbon footprint comparison charts 600 displays embodied carbon represented in a first color and operational carbon represented in a second color. The eco-feedback system 100 may calculate operational carbon emissions based on thermal design power (TDP) of CPUs and GPUs scaled by average utilization factors during request processing. The eco-feedback system 100 may calculate embodied carbon emissions by amortizing hardware manufacturing and deployment costs over a device lifetime of typically 5 years in data centers.

The carbon footprint comparison charts 600 demonstrate that the eco-feedback system 100 may achieve an average reduction in carbon emissions of 93.1% when the latency target is extended to one second across multiple applications. The carbon footprint comparison charts 600 indicate that for LLM applications, 99.6% of the reduction in carbon emissions occurs within the first second of latency extension. The carbon footprint comparison charts 600 indicate that for E-Commerce applications, 86.1% of the reduction occurs within the first second, while for Web Search applications, 98.1% of the reduction occurs within the first second, and for Social Network applications, 88.6% of the reduction occurs within the first second.

With continued reference to FIG. 6, the carbon footprint comparison charts 600 illustrate that different applications exhibit different carbon ranges per query as an aggregated effect of user latency tolerance and workload characteristics. The eco-feedback system 100 may utilize the carbon footprint comparison charts 600 to configure application-specific eco-mode parameters that maximize carbon reduction while maintaining user-acceptable latency levels. The arrows with text labels on each chart within the carbon footprint comparison charts 600 indicate the specific carbon reduction techniques from the three system-level carbon footprint reduction techniques 500 applied at different latency transition points for each application type.

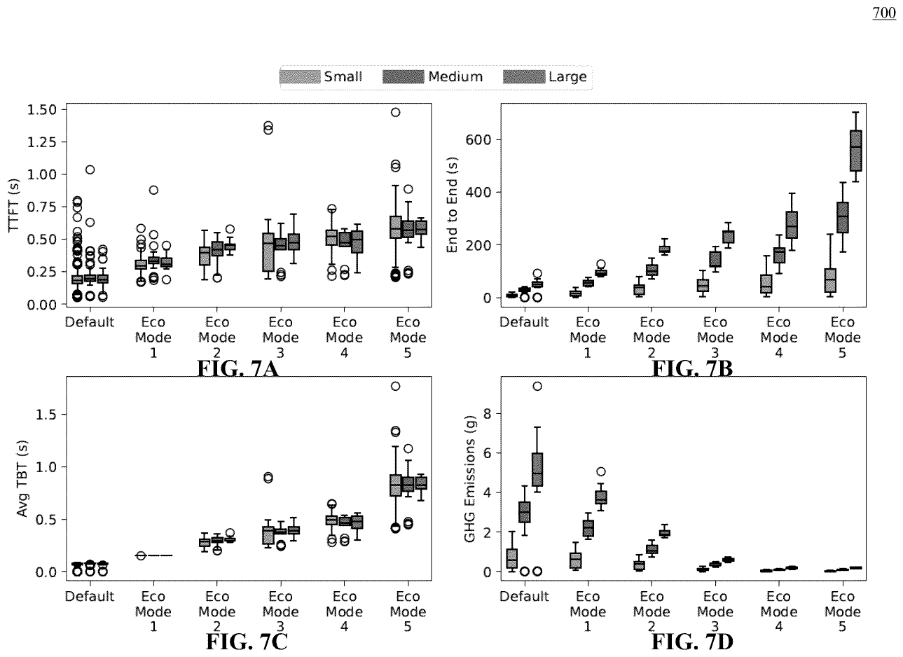

Referring to FIG. 7, a latency metrics comparison chart 700 illustrates different latency metrics and greenhouse gas emission results for different eco modes implemented by the eco-feedback system 100. The latency metrics comparison chart 700 includes four separate box plot panels arranged in a two-by-two grid format. The four box plot panels display Time to First Token (TTFT) measurements, End-to-End latency measurements, Average Token-by-Token (Avg TBT) latency measurements, and Greenhouse Gas (GHG) Emissions measurements across a Default mode and five Eco Modes (Eco Mode 1 through Eco Mode 5).

Referring to FIG. 7, a latency metrics comparison chart 700 illustrates different latency metrics and greenhouse gas emission results for different eco modes implemented by the eco-feedback system 100. The latency metrics comparison chart 700 includes four separate box plot panels arranged in a two-by-two grid format. The four box plot panels display Time to First Token (TTFT) measurements in FIG. 7A, End-to-End latency measurements in FIG. 7B, Average Token-by-Token (Avg TBT) latency measurements in FIG. 7C, and Greenhouse Gas (GHG) Emissions measurements in FIG. 7D across a Default mode and five Eco Modes (Eco Mode 1 through Eco Mode 5).

As further shown in FIG. 7A, a top left panel of the latency metrics comparison chart 700 displays Time to First Token (TTFT) measurements in seconds across the Default mode and five Eco Modes. The TTFT measurements represent the time elapsed from when a user submits a query until the first token of the response is generated. The latency metrics comparison chart 700 demonstrates that TTFT values increase gradually as the eco mode number increases from Default through Eco Mode 5, with larger requests exhibiting higher TTFT values than medium and small requests across all modes.

With continued reference to FIG. 7B, a top right panel of the latency metrics comparison chart 700 shows End-to-End latency measurements in seconds across the Default mode and Eco Mode configurations. The End-to-End latency measurements represent the total time from query submission to complete response delivery. The latency metrics comparison chart 700 demonstrates that larger requests exhibit consistently higher End-to-End latency values with greater spread than medium and small requests, and that End-to-End latency increases sharply at higher eco modes.

As further shown in FIG. 7C, a bottom left panel of the latency metrics comparison chart 700 presents Average Token-by-Token (Avg TBT) latency measurements in seconds. The Avg TBT latency measurements represent the average time between successive token generations during response streaming. The latency metrics comparison chart 700 demonstrates that Avg TBT values show gradual increases as the eco mode number increases from Default through Eco Mode 5. The eco-feedback interface of the eco-feedback system 100 may display detailed latency metrics including TTFT, End-to-End latency, and TBT for each response to provide users with transparency regarding the performance characteristics of selected eco modes.

With continued reference to FIG. 7D, a bottom right panel of the latency metrics comparison chart 700 displays Greenhouse Gas (GHG) Emissions measured in grams. The latency metrics comparison chart 700 illustrates that GHG emissions decrease monotonically as the eco mode increases across all request sizes. Larger requests produce higher GHG emissions than medium and small requests across all eco modes. The latency metrics comparison chart 700 demonstrates the latency-emissions tradeoff that becomes most pronounced at higher eco modes, where TTFT and Avg TBT rise gradually, End-to-End latency increases sharply, and GHG emissions decrease consistently.

The eco-feedback system 100 may apply different TTFT ratios and TBT ratios for each eco mode to calculate expected latency values. The Default mode may have a TTFT ratio of 1.0 and a TBT ratio of 1.0 as baseline values. Eco Mode 1 through Eco Mode 5 may have progressively increasing TTFT ratios and TBT ratios relative to the Default mode. Eco Mode 5 may have a TTFT ratio of 2.9112 and a TBT ratio of 10.3194 compared to the Default mode ratios of 1.0. The eco-feedback system 100 may multiply baseline TTFT and TBT values by the mode-specific ratios to calculate the expected latency for each eco mode configuration.

The eco-feedback system 100 may simulate LLM performance using a gemma model to estimate latency and carbon emission values across different hardware configurations. The eco-feedback system 100 may utilize the google/gemma-2-27b-it model for performance estimation. The gemma model simulation may evaluate performance across a wide range of possible input and output tokens on 1, 2, 4, and 8 GPUs with batch sizes ranging from 1 up to 256. The gemma model simulation may enable the eco-feedback system 100 to calculate expected TTFT, Avg TBT, End-to-End latency, and GHG emissions for each combination of eco mode, request size, and hardware configuration represented in the latency metrics comparison chart 700.

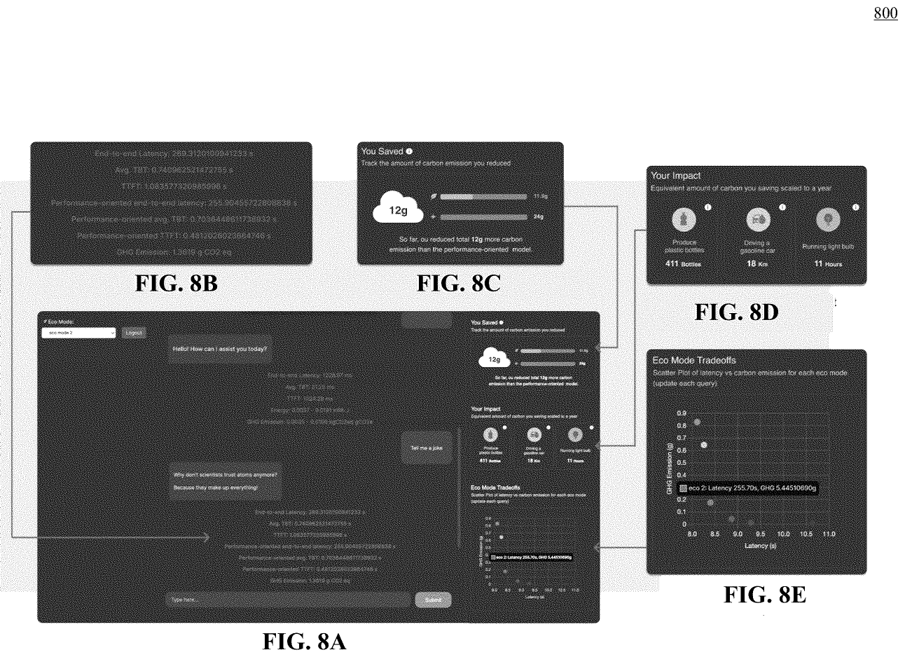

Referring to FIG. 8, an LLM eco-feedback interface 800 may be implemented by the eco-feedback system 100 to provide users with real-time feedback on carbon emissions associated with large language model queries. The LLM eco-feedback interface 800 adopts a commonly-used layout of an LLM chat system to ensure familiarity for users interacting with the eco-feedback system 100. The LLM eco-feedback interface 800 includes a chat interface area where users may submit queries and receive responses from the large language model.

Referring to FIG. 8A, an LLM eco-feedback interface 800 may be implemented by the eco-feedback system 100 to provide users with real-time feedback on carbon emissions associated with large language model queries. The LLM eco-feedback interface 800 adopts a commonly-used layout of an LLM chat system to ensure familiarity for users interacting with the eco-feedback system 100. The LLM eco-feedback interface 800 includes a chat interface area where users may submit queries and receive responses from the large language model.

With continued reference to FIG. 8B, the LLM eco-feedback interface 800 includes a drop-down menu positioned at the top left of the screen for users to select one of the five eco modes. The drop-down menu may enable users to choose between a Default mode and Eco Mode 1 through Eco Mode 5, where each eco mode defines a distinct latency profile tied to varying carbon impacts determined by back-end hardware configurations. The LLM eco-feedback interface 800 displays real-time carbon reduction estimates associated with the selected eco mode after each query is processed by the eco-feedback system 100.

As further shown in FIG. 8C, the LLM eco-feedback interface 800 includes a right sidebar that displays three types of eco-feedback data visualizations. A first visualization component labeled “You Saved” displays reductions of the eco mode relative to the default mode using numerical and graphical outputs. The “You Saved” visualization component may track the amount of carbon emissions reduced by using an eco mode compared to the Default mode, and may display the cumulative savings with a cloud icon and a progress bar indicating cumulative carbon reductions achieved through eco mode usage.

With continued reference to FIG. 8D, a second visualization component labeled “Your Impact” contextualizes annualized savings assuming 1,217 queries per year into tangible daily equivalents. The “Your Impact” visualization component displays carbon savings using tangible daily equivalents such as avoided PET bottle production at approximately 34-46 g CO₂ per 500 ml bottle based on PET resin production estimates. The “Your Impact” visualization component also displays equivalents for light bulb usage at 0.554 kg CO₂/kWh for a 100 W incandescent bulb on the US grid. The “Your Impact” visualization component further displays equivalents for gasoline car travel at approximately 235 g CO₂/km for gasoline internal combustion engine vehicles.

As further shown in FIG. 8E, a third visualization component labeled “Eco Mode Tradeoffs” presents a scatter plot visualization that displays latency and emissions across all modes. The “Eco Mode Tradeoffs” scatter plot allows direct comparison between the current mode and alternatives by plotting latency a horizontal axis against GHG emissions on a vertical axis for each eco mode. The “Eco Mode Tradeoffs” scatter plot updates with each query to allow users to visualize the relationship between response time and environmental impact across different mode configurations.

With continued reference to FIGS. 8A-E, the LLM eco-feedback interface 800 displays detailed latency metrics and corresponding GHG emissions for each response below the output text. The detailed metrics may include end-to-end latency, average TBT, TTFT, energy consumption, and GHG emission values for both the current eco mode and the performance-oriented baseline model. The LLM eco-feedback interface 800 provides transparency through info buttons positioned on each sidebar element that explain the underlying calculations for carbon emissions when activated by users.

As further shown in FIGS. 8A-E, the LLM eco-feedback interface 800 includes hoverable exclamation mark icons that provide additional explanations when users hover over the icons. The hoverable exclamation mark icons may be positioned adjacent to each of the three visualization components in the right sidebar to enable users to access detailed information about the calculation methodologies used by the eco-feedback system 100. The eco-feedback system 100 presents eco-feedback data in four different visualization formats through the LLM eco-feedback interface 800: detailed latency and GHG metrics displayed below output text, the “You Saved” component in the right sidebar, the “Your Impact” component in the right sidebar, and the “Eco Mode Tradeoffs” scatter plot in the right sidebar.

The eco-feedback system 100 may incorporate personalization based on users' personal environmental norms to optimize carbon savings across different user populations. The eco-feedback system 100 may classify users according to eco-mindedness levels based on responses to personal norm assessment questions or prior interaction patterns with eco-feedback features. Users classified as having higher eco-mindedness may receive higher latency times than users classified as having lower eco-mindedness. The personalization based on eco-mindedness levels may enable the eco-feedback system 100 to maximize aggregate carbon savings by applying more aggressive latency configurations to users who demonstrate greater willingness to accept latency tradeoffs for environmental benefits.

The eco-feedback system 100 may integrate distraction elements to engage users during increased latency periods associated with eco mode operation. The distraction elements may include progress bars that display the status of request processing to provide users with visual feedback during wait times. The distraction elements may include CAPTCHA challenges that occupy user attention while requests are being processed by remote data centers powered by renewable energy. The distraction elements may include small tasks that users may complete during the latency period to reduce perceived wait time. The distraction elements may include games such as the Google Chrome offline dinosaur game that engage users during periods of increased latency. The distraction elements may make delays less distinguishable to users by occupying user attention during the additional processing time associated with eco mode configurations.

The eco-feedback system 100 may stream partial outputs to limit perceived user wait time during eco mode operation. The eco-feedback system 100 may employ hybrid architectures that provide quick, lower-fidelity responses before refining the responses with higher-quality completions. The hybrid architectures may generate an initial response using a smaller or faster model configuration and subsequently refine the initial response using a larger or more accurate model configuration. The streaming of partial outputs may enable users to begin reading response content before the complete response has been generated, thereby reducing the perceived latency associated with eco mode configurations. The hybrid architectures may balance the tradeoff between response quality and perceived responsiveness by providing anticipatory cues or actionable feedback when slower eco modes are detected by the eco-feedback system 100.

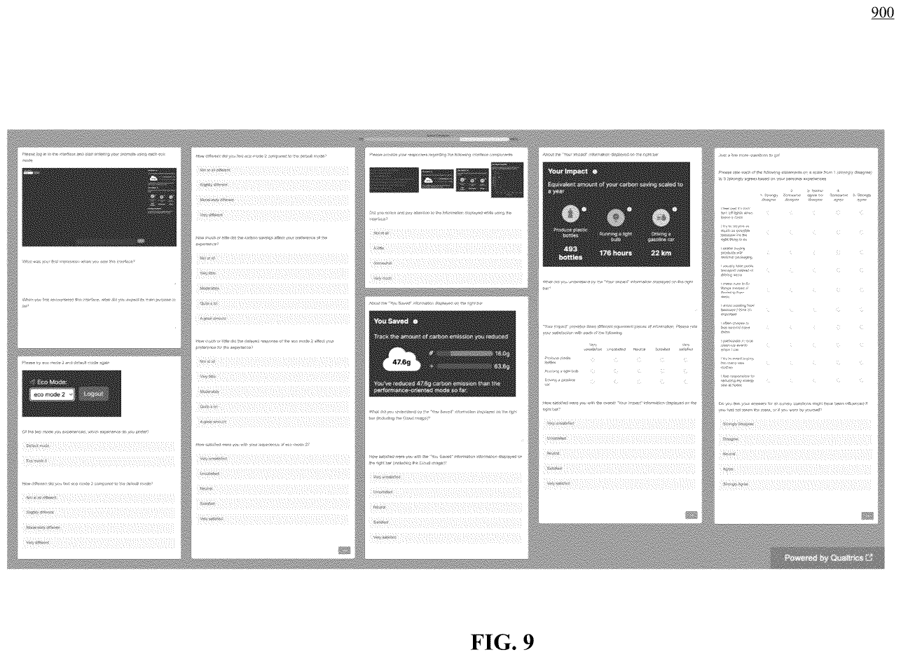

Referring to FIG. 9, survey interface screens 900 illustrate sample survey questions presented to participants during usability testing of the eco-feedback system 100.

The survey interface screens 900 include multiple pages displaying various question formats administered through a survey platform, with a progress bar positioned at the top of each page to help participants track their completion status. The survey interface screens 900 may be utilized by the eco-feedback system 100 to evaluate multiple aspects of participants' interactions with the LLM eco-feedback interface 800, including user comprehension of the interface, overall experience, and effectiveness of eco-feedback data in conveying environmental impact.

With continued reference to FIG. 9, the survey interface screens 900 present questions in multiple formats including text entry fields, multiple choice selections, matrix tables with Likert scale ratings, and rank-order tasks. The text entry fields may enable participants to provide open-ended responses describing their initial impressions of the interface and their expectations regarding the primary purpose of the eco-feedback system 100. The multiple choice selections may enable participants to indicate their preferences between default mode and eco mode configurations for each of the five eco modes implemented by the eco-feedback system 100.

As further shown in FIG. 9, the survey interface screens 900 include matrix tables with Likert scale ratings that enable participants to rate their satisfaction with eco mode experiences on a scale from 1 to 5. The matrix tables may also enable participants to rate how much the delayed response and carbon savings affected participant preference for the eco mode. The survey interface screens 900 may include questions asking participants to rate how different the eco mode was compared to the default mode on a scale from 1 to 4. The rank-order tasks within the survey interface screens 900 may enable participants to rank the four types of eco-feedback data visualizations in order of perceived impact on their overall experience.

With continued reference to FIG. 9, the survey interface screens 900 show interface context views displayed before relevant questions to provide participants with visual reference. The interface context views may include partial and full views of the LLM eco-feedback interface 800 to ensure participants have the context required to answer questions about specific interface components. The survey interface screens 900 may display questions evaluating user impressions of the interface, satisfaction ratings with eco-feedback information, understanding of displayed carbon savings data, and assessment of different eco-feedback visualization components including the “Your Impact” and “You Saved” sections of the LLM eco-feedback interface 800.

As further shown in FIG. 9, the survey interface screens 900 include questions measuring participants' likelihood of using eco-feedback interface settings and their personal environmental attitudes using scaled response options. The eco-feedback system 100 may measure behavioral personal norms using a 10-item scale with 1-5 points per item and a total possible score of 50 to examine whether higher levels of pro-environmental norms influence engagement with the interface. The 10-item norm assessment scale may be adapted from established pro-environmental behavior measures grounded in norm activation models and value-belief-norm theory. The survey interface screens 900 may present the 10-item norm assessment scale to classify participants according to low-norm, mid-norm, and high-norm groups based on their aggregate scores.

With continued reference to FIG. 9, the survey interface screens 900 may be utilized in conjunction with a side-by-side video comparison methodology for presenting eco-feedback and non-eco-feedback conditions to participants. The eco-feedback system 100 may present videos of eco-feedback and non-eco-feedback conditions side-by-side on the screen for user comparison. The side-by-side video comparison methodology may display experiential videos with headings at the top of each video indicating “[application] original loading” and “[application] eco-loading” to distinguish between the performance-optimized interface and the eco-feedback interface. The side-by-side video comparison methodology may enable participants to directly compare the user experience of the default mode against each of the five eco modes while viewing both conditions simultaneously.

The survey interface screens 900 may include questions assessing participants' familiarity with large language models based on self-reported familiarity levels and frequency of use on a 5-point scale. The survey interface screens 900 may include multiple-choice questions enabling participants to indicate their primary purposes for using LLM tools. The survey interface screens 900 may include a question asking participants to report their likelihood of future use by answering “If you could use this eco-feedback LLM daily, how likely would you be to use this service?” on a 5-point scale. The eco-feedback system 100 may utilize responses collected through the survey interface screens 900 to analyze correlations between participants' scores and their acceptance of different latency levels across the five eco modes.

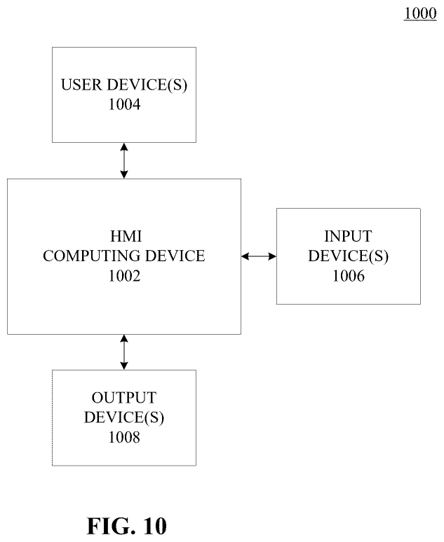

Referring to FIG. 10, a system 1000 may be configured to provide eco-feedback functionality in connection with internet services and large language model applications. The system 1000 may implement the eco-feedback system 100 described with reference to FIGS. 1A-1B to enable users to accept increased service latency in exchange for reduced carbon emissions. The system 1000 may coordinate the collection of user preferences, the processing of eco-mode configurations, and the presentation of eco-feedback data to users across multiple device types and service categories.

With continued reference to FIG. 10, the system 1000 includes an HMI computing device 1002 that serves as a central processing component for managing eco-feedback interface operations. The HMI computing device 1002 may coordinate communication between various components of the system 1000 to enable the delivery of eco-feedback functionality to users. The HMI computing device 1002 may process user inputs related to eco-mode selections, calculate carbon footprint reductions based on selected eco-modes, and generate appropriate eco-feedback displays for presentation to users. The HMI computing device 1002 may implement the three system-level carbon footprint reduction techniques 500 including renewable energy scheduling, batching, and requests parallelism based on the eco-mode configurations selected by users.

As further shown in FIG. 10, the system 1000 includes user devices 1004 communicatively coupled to the HMI computing device 1002 via a bidirectional connection. The user devices 1004 may enable users to interact with eco-feedback interfaces and receive information regarding carbon emissions associated with internet service usage. The user devices 1004 may include smartphones, tablets, laptop computers, desktop computers, or other computing devices capable of displaying the LLM eco-feedback interface 800 and receiving user inputs for eco-mode selection. The bidirectional connection between the user devices 1004 and the HMI computing device 1002 may enable real-time communication of user preferences and eco-feedback data between the components of the system 1000.

With continued reference to FIG. 10, the system 1000 includes input devices 1006 communicatively coupled to the HMI computing device 1002 via a bidirectional connection. The input devices 1006 may enable the system 1000 to receive user inputs such as eco-mode selections, latency preferences, and query submissions. The input devices 1006 may include touchscreens, keyboards, mice, voice input devices, or other input mechanisms that enable users to interact with the eco-feedback interfaces provided by the system 1000. The input devices 1006 may transmit user selections from the drop-down menu of the LLM eco-feedback interface 800 to the HMI computing device 1002 for processing and implementation of the corresponding eco-mode configuration.

As further shown in FIG. 10, the system 1000 includes output devices 1008 communicatively coupled to the HMI computing device 1002. The output devices 1008 may enable the system 1000 to present eco-feedback data visualizations, carbon savings information, latency metrics, and other environmental impact information to users. The output devices 1008 may include display screens, speakers, or other output mechanisms capable of presenting the visualization components of the LLM eco-feedback interface 800 including the “You Saved” component, the “Your Impact” component, and the “Eco Mode Tradeoffs” scatter plot. The output devices 1008 may display the detailed latency metrics including TTFT, End-to-End latency, and TBT values shown in the latency metrics comparison chart 700 for each response generated by the system 1000.

With continued reference to FIG. 10, the HMI computing device 1002 may process user inputs received from the input devices 1006 to determine the appropriate eco-mode configuration for each user request. The HMI computing device 1002 may manage eco-mode configurations that adjust service latency to reduce carbon emissions based on the user's selection from among the Default mode and Eco Mode 1 through Eco Mode 5. The HMI computing device 1002 may calculate carbon footprint reductions based on the selected eco-mode by applying the TTFT ratios and TBT ratios associated with each eco-mode configuration. The HMI computing device 1002 may generate appropriate eco-feedback displays for presentation through the output devices 1008 based on the calculated carbon savings and latency metrics.

As further shown in FIG. 10, the system 1000 may facilitate user engagement with carbon-saving features by providing real-time feedback on environmental impact associated with internet service requests and large language model queries. The HMI computing device 1002 may route user requests to geographically distant data centers powered by renewable energy when users select eco-modes that permit increased latency, thereby implementing the renewable energy scheduling technique from the three system-level carbon footprint reduction techniques 500. The HMI computing device 1002 may configure batch processing parameters and request parallelism settings based on the selected eco-mode to implement the batching and requests parallelism techniques from the three system-level carbon footprint reduction techniques 500. The system 1000 may present the carbon emission reductions achieved through the selected eco-mode configuration via the output devices 1008 using the visualization formats displayed in the LLM eco-feedback interface 800.

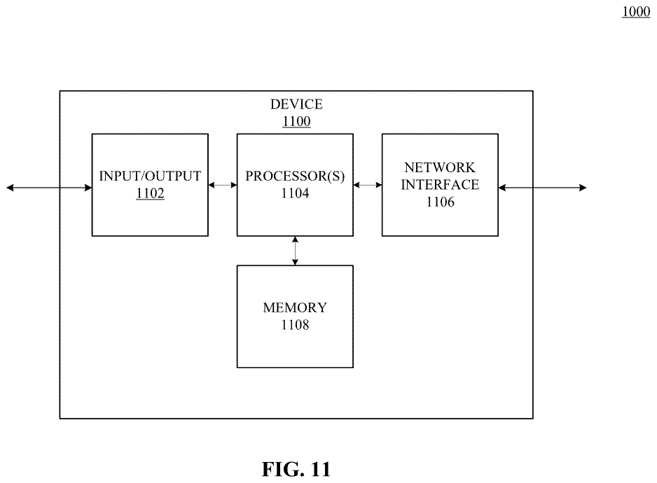

Referring to FIG. 11, a device 1100 may be used to implement aspects of the eco-feedback system 100. The device 1100 may be configured to perform the functions described with reference to the system 1000 shown in FIG. 10, including processing user inputs, managing eco-mode configurations, calculating carbon emissions, and generating eco-feedback visualizations for presentation to users. The device 1100 may be implemented as a server, a personal computer, a mobile device, or other computing apparatus capable of executing the operations associated with the eco-feedback system 100.

With continued reference to FIG. 11, the device 1100 includes an input/output 1102 that facilitates communication between the device 1100 and external components. The input/output 1102 may enable data entry from users and output display to users interacting with the eco-feedback system 100. The input/output 1102 may receive user selections from the drop-down menu of the LLM eco-feedback interface 800, including selections of the Default mode and Eco Mode 1 through Eco Mode 5. The input/output 1102 may transmit eco-feedback data visualizations to external display components, including the “You Saved” component, the “Your Impact” component, and the “Eco Mode Tradeoffs” scatter plot described with reference to FIG. 8.

As further shown in FIG. 11, the device 1100 includes a processor 1104 communicatively coupled to the input/output 1102. The processor 1104 may execute instructions to perform the various functions of the eco-feedback system 100. The processor 1104 may calculate carbon emissions associated with user requests based on the eco-mode configuration selected by the user. The processor 1104 may apply the TTFT ratios and TBT ratios associated with each eco-mode to calculate expected latency values for user requests. The processor 1104 may calculate operational carbon emissions based on thermal design power of CPUs and GPUs scaled by average utilization factors during request processing.

The processor 1104 may calculate embodied carbon emissions by amortizing hardware manufacturing and deployment costs over a device lifetime.

With continued reference to FIG. 11, the processor 1104 may manage latency configurations for the eco-feedback system 100 based on the eco-mode selected by users. The processor 1104 may configure batch processing parameters when users select eco-modes that permit increased latency, thereby implementing the batching technique from the three system-level carbon footprint reduction techniques 500. The processor 1104 may configure request parallelism settings to increase the number of requests processed simultaneously when users select eco-modes that permit increased latency. The processor 1104 may determine routing decisions for renewable energy scheduling by directing user requests to remote data centers powered by renewable energy when users select eco-modes that permit the additional latency associated with geographic distance.

As further shown in FIG. 11, the processor 1104 may generate eco-feedback visualizations for presentation to users through the input/output 1102. The processor 1104 may generate the detailed latency metrics displayed below output text in the LLM eco-feedback interface 800, including end-to-end latency, average TBT, TTFT, energy consumption, and GHG emission values. The processor 1104 may generate the “You Saved” visualization component by calculating the difference between carbon emissions of the selected eco-mode and carbon emissions of the Default mode. The processor 1104 may generate the “Your Impact” visualization component by converting carbon savings into tangible daily equivalents including avoided PET bottle production, light bulb usage, and gasoline car travel. The processor 1104 may generate the “Eco Mode Tradeoffs” scatter plot by plotting latency against GHG emissions for each eco-mode configuration.

With continued reference to FIG. 11, the device 1100 includes a network interface 1106 communicatively coupled to the processor 1104. The network interface 1106 may enable the device 1100 to communicate with external networks, data centers, and other devices. The network interface 1106 may facilitate the transmission of user requests to geographically distributed data centers, including data centers powered by renewable energy sources located in regions such as Iceland with low carbon intensity electricity. The network interface 1106 may enable the device 1100 to implement the renewable energy scheduling technique from the three system-level carbon footprint reduction techniques 500 by routing requests to remote data centers when users select eco-modes that permit increased latency.

As further shown in FIG. 11, the network interface 1106 may communicate with data centers having different carbon intensity values to enable carbon-aware request routing. The network interface 1106 may transmit requests to data centers powered by renewable energy with carbon intensity values of approximately 28 g CO₂/kWh when users select eco-modes permitting the additional latency of approximately 150 ms associated with routing to geographically distant locations. The network interface 1106 may transmit requests to local data centers with carbon intensity values of approximately 380 g CO₂/kWh when users select the Default mode or eco-modes that do not permit sufficient latency for renewable energy scheduling. The network interface 1106 may receive response data from the data centers and transmit the response data to the processor 1104 for processing and presentation through the input/output 1102.

With continued reference to FIG. 11, the device 1100 includes a memory 1108 communicatively coupled to the processor 1104. The memory 1108 may store instructions that the processor 1104 executes to perform the functions of the eco-feedback system 100. The memory 1108 may store eco-mode settings including the TTFT ratios and TBT ratios for each of the five eco-modes and the Default mode. The memory 1108 may store configuration parameters for the three system-level carbon footprint reduction techniques 500, including batch size parameters, GPU allocation parameters, and renewable energy scheduling parameters for each eco-mode.

As further shown in FIG. 11, the memory 1108 may store carbon emission calculations used by the processor 1104 to generate eco-feedback visualizations. The memory 1108 may store carbon intensity values for different data center locations to enable the processor 1104 to calculate carbon savings associated with renewable energy scheduling. The memory 1108 may store conversion factors for translating carbon savings into tangible daily equivalents, including the approximately 34-46 g CO₂ per 500 mL PET bottle, the 0.554 kg CO₂/kWh for a 100 W incandescent bulb, and the approximately 235 g CO₂/km for gasoline vehicles. The memory 1108 may store the annualized query assumption of 1,217 queries per year used by the processor 1104 to calculate the “Your Impact” visualization component.

With continued reference to FIG. 11, the memory 1108 may store user preference data collected through interactions with the eco-feedback system 100. The memory 1108 may store user eco-mode selections to enable the processor 1104 to track cumulative carbon savings displayed in the “You Saved” visualization component. The memory 1108 may store personal norm assessment scores to enable the processor 1104 to implement personalization based on users' environmental attitudes. The memory 1108 may store historical latency and carbon emission data for each user request to enable the processor 1104 to update the “Eco Mode Tradeoffs” scatter plot with each query. The device 1100 may be configured to implement the LLM eco-feedback interface 800 that allows users to select from multiple eco-modes, each defined by distinct latency profiles tied to varying carbon impacts determined by back-end hardware configurations stored in the memory 1108.

A number of implementations have been described. Nevertheless, it will be understood that various modifications may be made without departing from the spirit and scope of the disclosure. Accordingly, other implementations are within the scope of the following claims.

1. A system for reducing carbon emissions associated with internet services, comprising:
a processor configured to:
receive a user selection of an eco mode from a plurality of eco modes, wherein each eco mode of the plurality of eco modes defines a distinct latency profile associated with a corresponding carbon emission reduction;
configure at least one carbon footprint reduction technique based on the selected eco mode, wherein the at least one carbon footprint reduction technique includes at least one of renewable energy scheduling, batching, or request parallelism;
process a user request according to the configured at least one carbon footprint reduction technique, wherein processing the user request includes applying a latency increase corresponding to the selected eco mode;
calculate a carbon emission reduction associated with processing the user request according to the selected eco mode; and
generate an eco-feedback visualization displaying the calculated carbon emission reduction; and
a memory coupled to the processor and configured to store eco mode configuration parameters including latency ratios for each eco mode of the plurality of eco modes.

2. The system of claim 1, wherein the renewable energy scheduling comprises routing the user request to a remote data center powered by renewable energy instead of a local data center powered by carbon-intensive electricity.

3. The system of claim 2, wherein routing the user request to the remote data center adds approximately 150 milliseconds of latency to the user request.

4. The system of claim 1, wherein the batching comprises grouping the user request with other user requests for simultaneous processing to achieve higher GPU utilization.

5. The system of claim 4, wherein the processor is further configured to configure a batch size parameter based on the selected eco mode, wherein higher eco modes correspond to larger batch sizes.

6. The system of claim 1, wherein the request parallelism comprises increasing a number of requests processed simultaneously by a processing unit to improve server resource utilization.

7. The system of claim 1, wherein the eco-feedback visualization comprises:
a carbon savings component displaying a difference between carbon emissions of the selected eco mode and carbon emissions of a default mode;
an impact component displaying the calculated carbon emission reduction as tangible daily equivalents; and
a tradeoff component displaying a scatter plot of latency versus carbon emissions across the plurality of eco modes.

8. The system of claim 7, wherein the tangible daily equivalents comprise at least one of avoided PET bottle production, light bulb usage, or gasoline car travel.

9. The system of claim 1, wherein the latency ratios comprise a time to first token ratio and a token-by-token latency ratio for each eco mode of the plurality of eco modes.

10. The system of claim 1, wherein the processor is further configured to calculate the carbon emission reduction as a sum of an operational carbon emission reduction and an embodied carbon emission reduction.

11. The system of claim 10, wherein the operational carbon emission reduction is calculated based on thermal design power of processing units scaled by utilization factors, and wherein the embodied carbon emission reduction is calculated by amortizing hardware manufacturing costs over a device lifetime.

12. A method for reducing carbon emissions associated with internet services, comprising:
receiving, by a processor, a user selection of an eco mode from a plurality of eco modes, wherein each eco mode of the plurality of eco modes is associated with a distinct latency profile and a corresponding carbon emission reduction;
configuring, by the processor, at least one carbon footprint reduction technique based on the selected eco mode;
processing, by the processor, a user request according to the configured at least one carbon footprint reduction technique, wherein processing the user request includes applying a latency increase corresponding to the selected eco mode;
calculating, by the processor, a carbon emission reduction associated with processing the user request according to the selected eco mode; and
presenting, via an output device, an eco-feedback interface displaying the calculated carbon emission reduction to a user.

13. The method of claim 12, wherein configuring the at least one carbon footprint reduction technique comprises configuring renewable energy scheduling to route the user request to a remote data center powered by renewable energy.

14. The method of claim 13, wherein routing the user request to the remote data center adds approximately 150 milliseconds of latency to the user request.

15. The method of claim 12, wherein configuring the at least one carbon footprint reduction technique comprises configuring batching to group the user request with other user requests for simultaneous processing during inferencing.

16. The method of claim 12, wherein presenting the eco-feedback interface comprises displaying the calculated carbon emission reduction as tangible daily equivalents including at least one of avoided PET bottle production, light bulb usage, or gasoline car travel.

17. The method of claim 12, wherein calculating the carbon emission reduction comprises summing an operational carbon emission reduction based on energy consumption during request processing and an embodied carbon emission reduction based on amortized hardware manufacturing costs.

18. A non-transitory computer-readable medium storing instructions that, when executed by a processor, cause the processor to:
present an eco-feedback interface including a selection mechanism for a plurality of eco modes, wherein each eco mode of the plurality of eco modes defines a distinct latency profile associated with a corresponding carbon emission reduction;
receive a user selection of an eco mode from the plurality of eco modes;
configure at least one carbon footprint reduction technique based on the selected eco mode, wherein the at least one carbon footprint reduction technique adjusts at least one of data center routing, batch processing parameters, or request parallelism settings;
process a user request according to the configured at least one carbon footprint reduction technique;
calculate a carbon emission reduction associated with processing the user request according to the selected eco mode; and
display the calculated carbon emission reduction in the eco-feedback interface.

19. The non-transitory computer-readable medium of claim 18, wherein the instructions further cause the processor to display the calculated carbon emission reduction as tangible daily equivalents comprising at least one of avoided PET bottle production, light bulb usage, or gasoline car travel.

20. The non-transitory computer-readable medium of claim 19, wherein the instructions further cause the processor to display a scatter plot visualization showing latency versus carbon emissions across the plurality of eco modes, wherein the scatter plot visualization updates with each processed user request.
